(19) United States
(12) Patent Application Publication
(10) Pub. No.: US 2014/0346166 A1
(43) Pub. Date: Nov. 27, 2014

(54) ACCESS PORT FOR CONTAINERS WITH DOORS

(71) Applicants: Benjamin M. Horvath, Franklin, OH (US); Kody Lee Traylor, Fairborn, OH (US)

(72) Inventors: Benjamin M. Horvath, Franklin, OH (US); Lee R. Traylor, Tipp City, OH (US)

(21) Appl. No.: 14/286,428

(22) Filed: May 23, 2014

Related U.S. Application Data
(60) Provisional application No. 61/826,535, filed on May 23, 2013.

(51) Int. Cl. E06B 7/32; B65D 88/12; E06B 3/50

(52) U.S. Cl. CPC E06B 7/32; E06B 3/50; B65D 88/121
USPC 220/1.5; 49/168; 49/506

(57) ABSTRACT

An access port for installation on a door of a container is disclosed in kit form, and as an installation on a container. The access port is installed on a container surface, such as a door, close to a latch, lock, handle, release or other device utilized to close and hold the container door closed from the outside. A hole is cut into the container surface. A frame having an aperture is positioned on the outside of the container such that the aperture of the frame aligns with the hole. A cover forms a door or other suitable structure on the inside of the container that closes the hole through the container. The cover can be manually transitioned between the open and closed positions from within the container. However, the cover cannot be transitioned from the closed position to the open position from outside of the container.

### CROSS REFERENCE TO RELATED APPLICATIONS

This application claims the benefit of U.S. Provisional Patent Application Ser. No. 61/826,535, filed May 23, 2013, entitled ACCESS PORT FOR CONTAINERS WITH DOORS, the disclosure of which is hereby incorporated by reference.

### BACKGROUND

The present disclosure relates in general to an access port and in particular, to an access port for a container such as a semi trailer having a door, where an individual can reach through the access port from within the container to unlatch and open the container door.

A semi-trailer is a trailer that is suitable for travel over interstates, highways and other roadways, which is pulled by a truck (sometimes referred to as a road tractor). The most common type of trailer, known as a box trailer, is essentially a box-shaped container on wheels, making the trailer suitable for temporarily storing and hauling various types of cargo. For instance, a box trailer is typically around 8 feet (about 2.44 meters) wide and about 13 feet (about 3.96 meters) high. Semi-trailers also have a relatively long overall length, e.g., a length ranging from about 28 feet (about 8.5 meters) to over 50 feet (about 15.24 meters) in length in some circumstances.

Box trailers have one or more doors, typically located along the back of the trailer along the width thereof, to provide ingress and egress for loading contents into, and unloading contents from, the trailer. For instance, one or more workers operating forklift trucks, pallet jacks and other materials handling devices can cooperate to move cargo into the trailer for transportation to a desired destination. Once a trailer is loaded, the doors can be closed and latched shut from the outside. The latches prevent the doors from unintentionally opening, such as when the trailer is being hauled down a road to the desired destination.

### BRIEF SUMMARY

According to aspects of the present disclosure, a kit of components provides an access port for installation on a container. The access port comprises a frame and a cover. In an illustrative implementation, the frame has a first frame member that has an aperture therethrough and a second frame member, also having an aperture therethrough. The second frame member further has a locking feature. The cover has a locking structure that mates with the locking feature of the second frame member. The locking structure of the cover interacts with the locking feature of the second frame member such that the cover releasably couples to the second frame member so as to sealingly close off the aperture through the second frame member when the locking structure of the cover engages the locking feature of the second frame member defining a closed position. Also, the cover at least partially detaches from the second frame member so as to expose the aperture through the second frame member when the locking structure of the cover is disengaged from the locking feature of the second frame member, thus defining an open position. The cover is manually operable to transition between the closed position and the open position from a side defined by the second frame member; and the cover is not manually operable between the closed position and the open position from a side defined by the first frame member.

For instance, the locking feature of the second frame member may comprise at least one locking panel that forms a slot, and a corresponding release recess. In this regard, the locking structure of the cover includes at least one locking tab dimensioned relative to the release recess and locking panel such that when the cover is engaged against the second frame member and is rotated, the locking tab seats into the slot.

According to still further aspects of the present disclosure, the first frame member and the second frame member are an integral assembly where the first frame member defines a flange and the second frame member defines an extension from the flange. Alternatively, the second frame member may be distinct from the first frame member. In this regard, the first frame member and the second frame member couple to each other, such as by using at least one fastener that passes through the first frame member surface and the second frame member surface so as to align the apertures through the first frame member and the second frame member.

According to still further aspects of the present disclosure, a kit of components is provided, which provides an access port when installed on a container. The kit comprises frame and a cover. The frame has a first frame member having an aperture therethrough. The cover has a hinge. The frame is configured to overlie a hole cut into a corresponding container such that the aperture aligns with the hole when the frame is mounted on the outside of the container. Also, the cover is dimensioned to be larger than the hole cut in a corresponding container. Further, the hinge of the cover is configured to attach to an inside surface of a container proximate to the hole such that when the cover is closed, the cover overlies the hole and when the cover is open, the hole is exposed through the frame.

According to still further aspects of the present disclosure, the cover may further comprise a latch. The latch of the cover latches to a corresponding latch mechanism, which is attached to the inside surface of the container, such that the latch can be operated from the inside of the container but not from the outside of the container. As yet another example, the hinge may comprise a pivot such that the cover can be opened relative to the hole by rotating the cover thus pivoting the cover away from the hole.

### BRIEF DESCRIPTION OF THE SEVERAL VIEWS OF THE DRAWINGS

FIG. 1 is an illustration of the back of a trailer having two closed trailer doors, with an access port adjacent to a latch of one of the doors, according to aspects of the present disclosure;

FIG. 2 is an illustration of the trailer of FIG. 1, with one door open to show the inside of the access port according to aspects of the present disclosure;

FIG. 3 is an illustration of a frame of an access port (outside view), according to aspects of the present disclosure;

FIG. 4 is a side view of the frame of FIG. 3 taken along lines A-A;

FIG. 5 is an illustration of the frame of FIG. 3 (inside view), according to aspects of the present disclosure;

FIG. 6 is an illustration of a cover for the access port of FIGS. 3-5, according to aspects of the present disclosure;

FIG. 7 is a side view of the cover of FIG. 6;

FIG. 8 is an illustration of a first frame member of an access port (outside frame), according to further aspects of the present disclosure;

FIG. 9 is an illustration of a second frame member (inside frame) that mates with the first frame member of FIG. 8, according to aspects of the present disclosure;

FIG. 10 is a side view of the second frame member of FIG. 9, according to aspects of the present disclosure;

FIG. 11 is an illustration of a cover for the access port of FIGS. 8-10, according to aspects of the present disclosure;

FIG. 12 is an illustration of a cover tethered to the second frame member of an access port, according to aspects of the present disclosure;

FIG. 13 is an illustration of a flap in the aperture of an access port according to further aspects of the present disclosure;

FIG. 14 is an illustration of a cover having a light reflective surface, according to aspects of the present disclosure;

FIG. 15 is an illustration of an exemplary combination hinge/latch cover, according to aspects of the present disclosure;

FIG. 16 is an illustration of an exemplary cover that includes a hinge attachment according to aspects of the present disclosure; and

FIG. 17 is an illustration of another latch and access port configuration according to further aspects of the present disclosure.

### DETAILED DESCRIPTION

Various aspects of the present disclosure are directed to an access port for a container body such as a semi trailer (e.g., a box trailer), a cargo container or other suitable storage container having a door. In general terms, the access port is installed on a container surface, such as a door, adjacent to (or otherwise close to) a latch, lock, handle, release or other device utilized to close and hold the container door closed from the outside.

The access port may be provided as a kit of components for installation on a container, or the access port may be provided integrally with a container.

As will be described in greater detail herein, where the access port is provided as a kit of components that are assembled to define an access port on a container, a hole is cut into the container surface. A frame having an aperture is positioned on the outside of the container such that the aperture of the frame aligns with the hole. A cover forms a door or other suitable structure on the inside of the container that fills, covers, blocks or otherwise closes the hole through the container surface. In an illustrative implementation, the cover is arranged to releasably couple to the frame so as to sealingly close off the aperture through the frame when the cover engages the frame in a closed position. The cover also at least partially detaches or otherwise opens from the frame so as to allow access from within the container body through the hole in the container surface, defining an open position. In this regard, the cover can be manually transitioned between the open and closed positions from within the container. However, the cover cannot be transitioned from the closed position to the open position from the outside of the container.

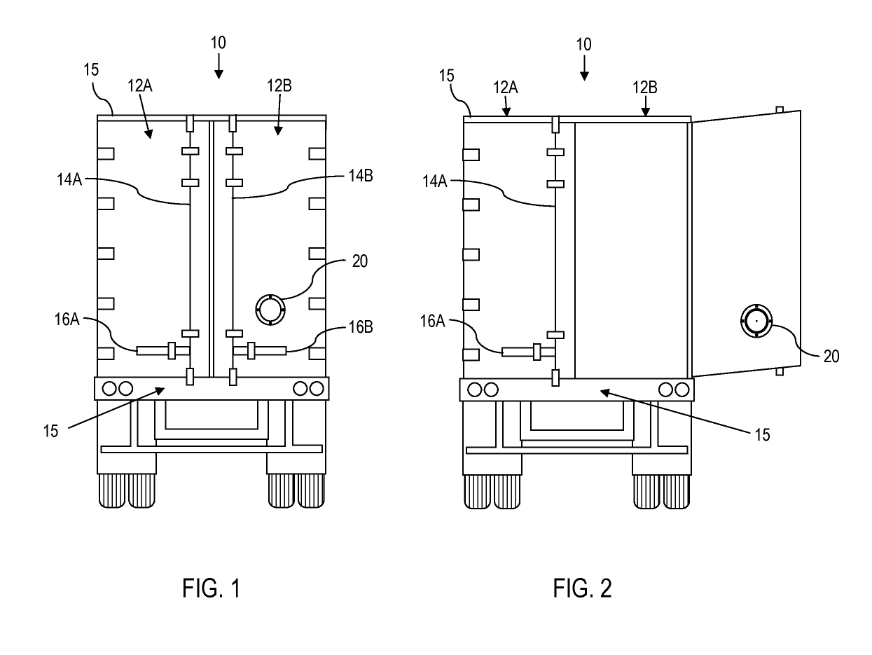

Referring now to the drawings, and in particular to FIGS. 1 and 2, a container 10 is implemented for purposes of clarity of discussion, as a box-type semi trailer. The container 10 includes two doors, including a first door 12A and a second door 12B. A rod 14A extends vertically (height-wise) near the non-hinged vertical edge of the first door 12A so as to engage a frame 15 of the container 10. A door opening mechanism 16A, illustrated as a latch for purposes of example, is utilized to release the rod 14A so that the first door 12A can be opened or latched closed. Similarly, a rod 14B extends vertically (height-wise) near the non-hinged vertical edge of the second door 12B so as to engage the frame 15 of the container 10. A corresponding door opening mechanism 16B, e.g., a latch, is utilized to release the rod 14B so that the second door 12B can be opened or latched closed.

Notably, in practice, there are a number of different types of door opening mechanisms 16 that allow a door 12 to open and close relative to the frame 15 of the container 10. Moreover, there can be various arrangements of hinges, rods, and other structures that work to enable a corresponding door 12 to open or close. However, in general, regardless of the type of door opening mechanism 16, each will include a door opening device, which can be implemented as a latch, lever, hook, lock, handle, release or other structure, that is positioned on the outside of the container 10, which can be operated to permit opening of the door(s), e.g., 12A, 12B. Further, the door opening mechanism 16 is typically not accessible from the inside of the container 10.

According to aspects of the present disclosure, the container 10 includes at least one access port 20. For purposes of clarity of discussion herein, the access port 20 is positioned on door 12B. However, in practice, the location of the access port 20 will depend upon the configuration and location of the door opening mechanism 16. Referring specifically to FIG. 1, the access port 20 cannot be opened from outside of the container 10. However, it is possible that someone could become trapped within the container, e.g., where wind blows the door 12B shut with sufficient force to cause the door opening mechanism 16B, e.g., a latch, to engage while someone is inside the container. If this happens, the trapped person can easily open the access port 20 from within the container 10. The port opening is not large enough for a person to pass through. However, the person can reach through a hole from the inside out, so as to be able to grab and operate the door opening mechanism 16, e.g., a latch as illustrated. Referring to FIG. 2, once the door 12B is open, the person can exit the container 10 without incident.

As such, in illustrative implementations, the access port can be readily opened only from the side opposite the door opening mechanism 16, e.g., from inside the container, which is opposite the latch, hook, lock, release, rod, etc., that is located on the outside of the container. Moreover, the access port 20 is separate from, and independent from the door opening mechanism 16. As such, the access port 20 can be used with any variety of door opening mechanism 16 without requiring modification of the door opening mechanism 16, and without inhibiting, interfering with, or otherwise affecting the use, fitness or suitability of the door opening mechanism 16.

Access Port:

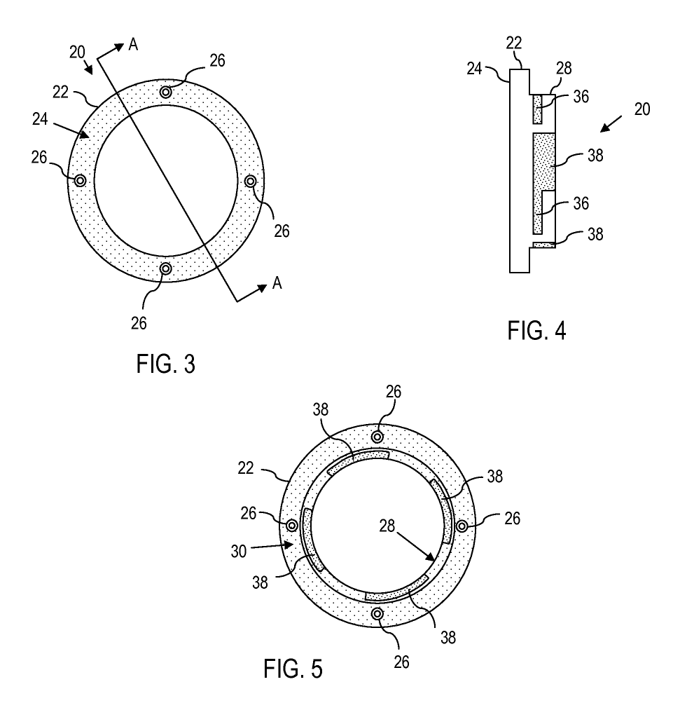

An exemplary implementation of an access port 20 according to aspects of the present disclosure is illustrated with reference to FIGS. 3-7. The access port 20 of FIGS. 3-7 defines a two-piece assembly including a frame and a cover.

Referring specifically to FIG. 3, the illustrated access port 20 defines a frame having a first frame member 22. As will be described in greater detail herein, the first frame member 22 is the frame portion that is installed on the outside of the container (e.g., as illustrated as being installed on the door 12B in FIG. 1). The first frame member 22 has a first frame member surface 24, and an aperture through the first frame member surface 24. As illustrated, the first frame member surface 24 is generally annular. However, other shapes may alternatively be implemented. For instance, the first frame member surface 24 can be rectangular or any desired shape. Moreover, the aperture may be round, or take on any desired shape. Still further, the first frame member surface 24 need not completely bound or otherwise form a perimeter around the aperture. For instance, the first frame member surface 24 could be U-shaped or take on other configurations.

The first frame member 22 includes a plurality of alignment features 26. The alignment features 26 serve as an area to assist an installer in aligning the frame on the door. The alignment features 26 are also used as locations to fasten the first frame member 22 to the door of the container, e.g., using rivets, screws, or other suitable fasteners.

Referring to FIG. 4, a side cutaway view, taken along lines A-A of FIG. 3, illustrates the profile of the access port 20. In the illustrative implementation, the first frame member 22 defines a flange of the frame and a second frame member 28 defines an extension that extends out from the flange. The second frame member 28 thus defines an extension that projects from the flanged portion through the container wall when the access port 20 is suitably installed. As an example, a six inch (15.24 centimeters (cm)) hole may be cut through a container surface, e.g., a wall or door that is proximate to the associated door opening mechanism. In this example, the outside diameter of the second frame member 28 may be also about 6 inches (15.24 cm) so as to securely fit into the hole in the container. The flange defining the first frame member 22 in this example, is larger than about 6 inches (15.24 cm) to enable fasteners placed through the alignment features 26 to secure to an exterior surface of the container wall, whereas the second frame member 28 extends through the container wall into the interior volume of the container. In practice, the hole may be slightly smaller than 6 inches (15.24 cm) so long as an expected user can reach through the hole and grasp the door opening mechanism so as to open the door. Alternatively, the hole can be larger than 6 inches (15.24 cm). However, the hole should not be so large that a person could fit through the door. For instance, the hole may be less than two feet (about 61 cm) in diameter, and is preferably less than one foot (about 30.48 cm) in diameter.

The hole may be cut close enough to the door opening mechanism of the container to be within an arm-reach of the door opening mechanism, when reaching through from inside the container to the outside of the container with the door shut. In an illustrative implementation, the hole is cut approximately one foot or less (about 30 centimeters) from the corresponding door opening device, e.g., the door opening mechanism 16B, e.g., latch, as best illustrated in FIGS. 1 and 2. In practice, the location of the hole may be slightly more or less than the above-example, depending upon the size of the access port 20, the location of the door opening device, the type of door opening device, etc.

For a container such as a conventional box trailer, the thickness of the wall/door surface may range from about 0.5 inches (1.27 cm) to about 0.75 inches (1.91 cm). The depth of the second frame member 28 (length that extends from the flange) approximately matches the thickness of the container wall so that the end of the extension is about flush with the interior surface of the container when the access port 20 is installed into the container hole. However, the second frame member 28 can alternatively extend into the interior volume of the container.

The second frame member 28 includes a locking feature. The illustrated exemplary implementation includes multiple, e.g., four, locking features, which are implemented as grooves into the inside surface of the second frame member 28. More particularly, each locking feature is implemented as a pattern of a locking panel 36 and a corresponding release recess 38. Each release recess 38 extends to the top edge of the major surface of the second frame member 28 following the contour thereof, and is adjacent to the aperture through the frame. Correspondingly, each locking panel 36 is a groove in the inside surface of the second frame member 28 that follows the contour of the frame, e.g., generally parallel to the major surface of the second frame member 28. However, the locking panel 36 may alternatively spiral, twist, wind or otherwise define a pattern.

Referring specifically to FIG. 5, the access port 20 is illustrated in a view opposite of FIG. 3. That is, the access port 20 is illustrated looking down on the extension and the back surface of the flange (e.g., from the perspective of inside the container when the access port 20 is installed). As illustrated, the first frame member 22 also includes a frame member surface 30 (which is the surface on the side of the flange opposite the first frame member surface 24 of FIG. 3). The frame member surface 30 is the frame portion that contacts the outside container surface.

As illustrated, the second frame member surface 30 is generally annular. However, in a manner analogous to that described with reference to FIG. 3, other shapes may alternatively be implemented. For instance, the second frame member surface 30 can be rectangular or any desired shape. Moreover, the aperture may be round, or take on any desired shape. Still further, the second frame member surface 30 need not completely bound or otherwise form a perimeter around the aperture.

As noted in greater detail above, in the illustrative implementation, the locking feature is located adjacent to a peripheral edge of the second frame member 28. More particularly, the locking feature is integrated into a rim of the extension defining the second frame member 28.

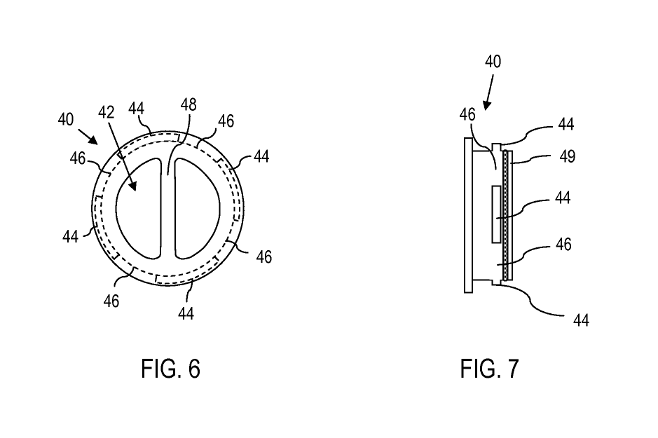

Referring to FIG. 6, the access port 20 also includes a cover 40. The cover 40 has a body 42 that is generally dimensioned to correspond with the size of the hole cut into the door and/or the dimensions of the second frame member 28. The cover 40 also has a locking structure. For instance, the illustrated locking structure is implemented by a plurality of locking tabs 44 that are spaced by recessed regions 46. FIG. 6 illustrates that the locking tabs 44 extend around the circumference of the cover 40. In the illustrative example, there are four tabs, but that number can vary depending upon the application. The cover 40 may also include other features, such as a handle 48 that is on the inside only. The handle 48 can make it easier for a person to remove or otherwise open the cover 40 relative to the second frame member 28 to utilize the access port 20.

Referring to FIG. 7, a side view of the cover 40 of FIG. 6 is illustrated. As illustrated, the locking tabs 44 extend out in a radial direction along the outside surface of the axial length of the cover 40. The cover 40 may also include a gasket 49, e.g., a rubber seal, o-ring, or other suitable feature, to prevent leaking through the access port 20 when the access port 20 is installed on a container. As such, the gasket 49 forms a waterproof seal between the cover 40 and the frame when the cover is engaged with the frame of the access port 20.

Referring to FIGS. 3-7 generally, in use, the locking tabs 44 of the cover 40 are aligned with the release recesses 38 of the second frame member 28. When the locking tabs 44 are properly aligned, the user can press the cover 40 against the second frame member 28 such that the locking tabs 44 recess into the second frame 28. The user then turns, twists or otherwise rotates the cover 40 such that the locking tabs 44 are locked into the locking panels 36 of the second frame member 28. In this regard, the locking panels 36 form slots that receive and secure the locking tabs 44 of the cover 40. Thus, when the cover is engaged against the second frame member and is rotated, the locking tab seats into the slot. To remove the cover 40, the cover 40 is twisted until the locking tabs 44 release from the locking panels 36 and once again become aligned with the release recesses 38. In this manner, the access port can be opened and closed from the inside of the container, but is locked from the outside. That is, the cover cannot be removed from the outside of the container.

Thus, the exemplary cover 40 releasably couples to the second frame member 28 so as to sealingly close off the aperture (and corresponding hole in the container) when the locking structure of the cover 40 engages the locking feature of the second frame member 28. Moreover, the cover 40 at least partially detaches from the second frame member 28 so as to allow the aperture to serve as an opening through the access port 20 and corresponding hole in the container. For instance, the cover 40 described with reference to FIGS. 6 and 7 completely separates from the second frame member 28. However, other implementations may include a cover that hinges, links, snaps, slides or otherwise moves relative to the second frame member 28.

An optional inside frame may be provided to serve as an inside frame about the hole in the container, if desired. That is, the optional inside frame (not shown) would form a frame about the end of the second frame member 28 and cap 40, e.g., engaging the inside surface of the container wall. This may be used as a trim piece to cover the hole in the container wall.

In summary, the cover 40 releasably couples to the second frame member 28 so as to sealingly close off the second frame member aperture when the locking structure of the cover 40 engages the locking feature of the second frame member 28, thus defining a closed position. The cover 40 at least partially detaches from the second frame member 28 so as to expose the aperture through the second frame member 28 when the locking structure of the cover 40 is disengaged from the locking feature of the second frame member 28, thus defining an open position. The cover is manually operable to transition between the closed position and the open position from a side defined by the second frame member 28, i.e., from within the container. The cover 40 is not manually operable between the closed position and the open position from a side defined by the first frame member 22, i.e., from the outside of the container. Thus, the cover 40 cannot be removed by reaching from outside the container, through the aperture to access the cover 40.

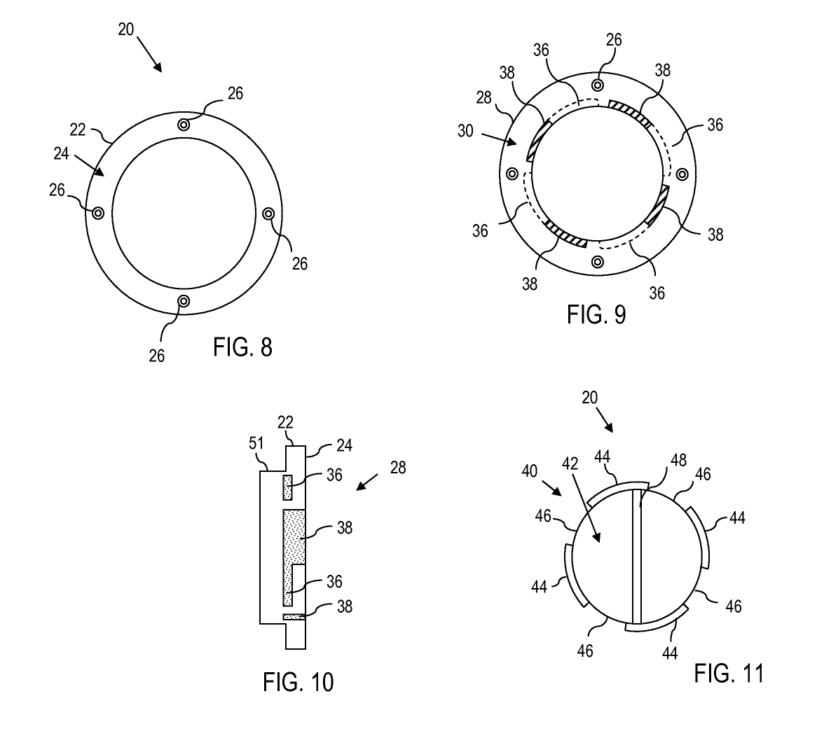

Referring to FIGS. 8-11, as an alternative configuration, the access port 20 may be implemented as a three-piece assembly, including an outside frame member, an inside frame member, and a cover that couples to the inside frame member, the outside frame member, or both.

With reference specifically to FIG. 8, the access port 20 includes a first frame member 22 e.g., a ring as illustrated. For instance, in this configuration, the first frame member 22 may be flat e.g., to secure directly to the outside surface of the container. Alternatively, the first frame member 22 may include a flanged portion and an extension such that the ring secures to the outside of the container and the extension extends into the hole cut into the container (e.g., in a manner analogous to the second frame member without the locking feature).

Referring to FIG. 9, the second frame member 28 in this illustrative example, is implemented as a frame member that is a separate piece from the first frame member 22 and which secures to the inside surface of the container. The second frame member 28 has a second frame member surface 30, and an aperture through the second frame member surface 30. As illustrated, the second frame member surface 30 is generally annular. However, in a manner analogous to that described more fully herein, other shapes may alternatively be implemented. For instance, the second frame member surface 30 can be rectangular or any desired shape. Moreover, the aperture may be round, or take on any desired shape. Still further, the second frame member surface 30 need not completely bound or otherwise form a perimeter around the aperture. For instance, the second frame member surface 30 could be U-shaped or take on other configuration.

As such, in an illustrative implementation, the first frame member 22 is configured for mounting on the outside of a container surface and the second frame member 28 is distinct from the first frame member 22 and is configured for mounting to the inside surface of the container. For instance, in this implementation, an installer cuts a hole through the container (e.g., by cutting a hole in the container door, wall or other surface) that is proximate to the associated door opening mechanism as noted above. For instance, the hole may be cut close enough to be within an arm-reach of the door opening mechanism. The first frame member 22 is positioned on the outside of the container so that the first frame member aperture aligns with the hole. The second frame member 28 is positioned on the inside of the container so that the aperture of the second frame member also aligns with the hole. The alignment features 26 on the first frame member are aligned in register with the alignment features 26 on the second frame member, and the frame is secured to the door, such as riveting through the alignment features 26.

The second frame member 28 includes a locking feature analogous to that described with reference to FIGS. 4-5. In the illustrative example, the locking feature is along the inside edge of the second frame member 28. Moreover, the locking feature, as illustrated, includes a plurality of locking panels 36 and corresponding release recesses 38 as described more fully herein. However, the locking feature(s) could alternatively be located along the outside edge of the second frame member 28.

The second frame member 28 may be a generally ring-shaped member. Alternatively, as best illustrated in FIG. 10, the second frame member 28 can include an extension 51 that extends at least partially into the hole in the cover when the second frame member 28 is mounted to the inside surface of a container.

Referring to FIG. 11, the cover 40 is similar to the cover described with reference to FIGS. 6-7. For instance, the cover 40 may include locking tabs 44 that cooperate with the locking panels 36 and corresponding release recesses 38 of the second frame member 28. As such, unless otherwise stated, the operation of the cover 40 relative to the second frame member 28 is analogous to the operation of the cover as described above with reference to FIGS. 2-7.

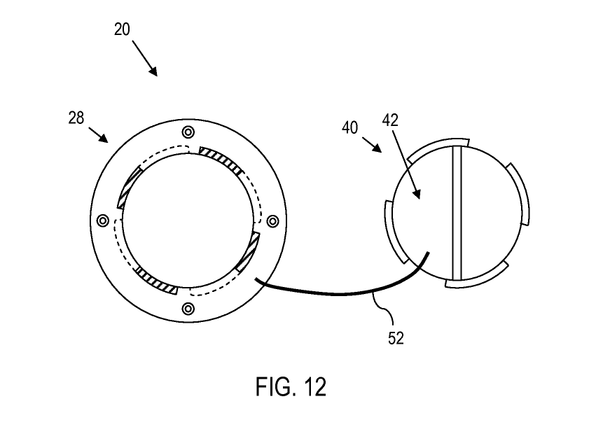

Referring to FIG. 12, regardless of the embodiment, the cover 40 may be tethered to the frame, e.g., the second frame member 28 as illustrated, by a connector 52, e.g., using a cable, cord, tie or other suitable structure. For instance, the connector 52 may comprise a metal or plastic wire. The tether provided by the connector 52 prevents the cover 40 from getting lost when the cover 40 is removed from the second frame member 28.

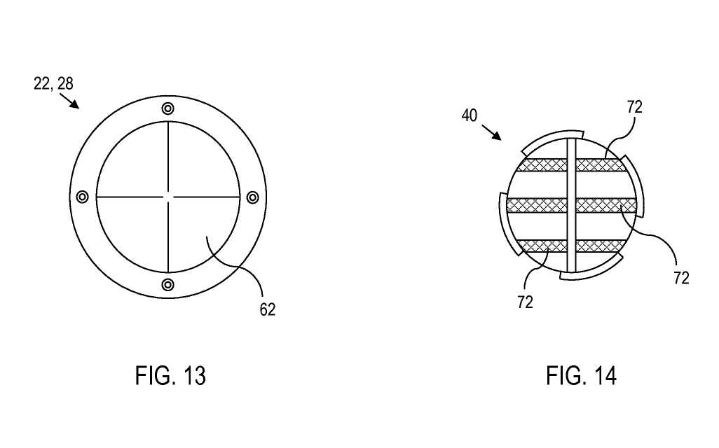

Referring to FIG. 13, the first frame member 22 or the second frame member 28 or both, may include a flap 62. The flap 62 serves as a seal, and may be rubber for example. As illustrated, the flap 62 is segmented so that an individual can reach through the flap 62. In illustrative implementations, the flap 62 defines the cover (e.g., such that a separate cover 40 of FIG. 6 is unnecessary). Alternatively, the flap 62 can be used in combination with a separate cover 40. For instance, in an illustrative implementation, the flap 62 is implemented as a segmented flap (e.g., four segments) that is positioned between the first and second frame members 22, 28 so as to seal the apertures (and corresponding container hole) therebetween.

Referring to FIG. 14, according to still further aspects of the present disclosure, the cover 40 includes a reflective feature 72, e.g., reflective/emergency tape that is positioned on the inside so as to provide an indication of the location of the cover 40 within the container in situations where the inside of the container is dark. For instance, as illustrated, the reflective feature 72 is implemented as rows of reflective tape. However, any arrangement of reflective surface treatment may be implemented.

In this regard, according to still further aspects of the present disclosure, a reflective tape, reflective paint, etc., may be applied to the cover 40, first frame member 22, second frame member 28 or combinations thereof, e.g., to allow a user to identify the location of the access port 20 from within the container, even in dimly lit or poorly lit environments.

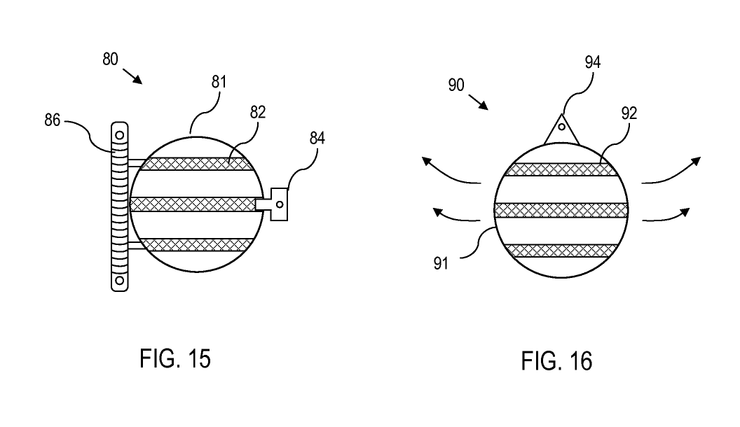

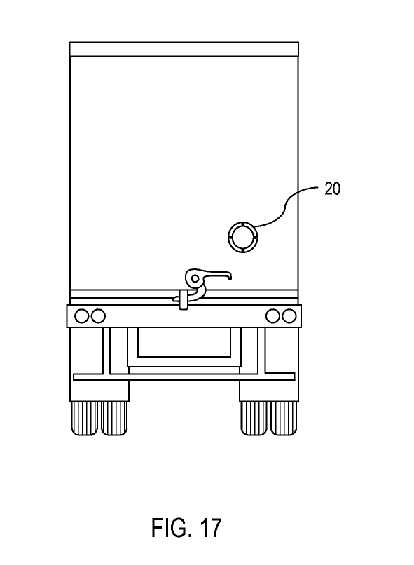

Referring to FIG. 15, an alternative arrangement of the cover is illustrated, according to further aspects of the present disclosure. As illustrated, a cover 80 includes a cover surface 81 that is dimensioned to cover the corresponding apertures through the first and second frame members 22, 28. Thus, the cover 80 seals the hole through a corresponding container. A reflective feature 82 is optionally provided on the cover surface. The reflective feature 82 is analogous to the reflective feature of 72.

The cover 80 differs from the cover 40 in the manner in which the cover interacts with the second frame member 28. Where the cover 40 of FIGS. 6, 7 twists to lock and unlock relative to the second frame member 28, the cover 80 includes a latch 84 and a corresponding hinge 86. Thus, the tabs 44 in the cover 40 are replaced with the latch 84 and the hinge 86 of the cover 80.

In an illustrative example, the cover 80 is dimensioned to be larger than the hole cut in a corresponding container and the hinge 86 of the cover 80 is configured to attach to an inside surface of a container proximate to the hole such that when the cover is closed, the cover overlies the hole and when the cover is open, the hole is exposed through the frame.

In an implementation where the first frame member and the second frame member are a single, integral structure, e.g., the implementation of FIGS. 3-7, the second frame member 28 need not include the locking feature as described with reference to FIGS. 4-5 because the cover 80 can latch directly to the container surface. Alternatively, where the first and second frame members are separate pieces, such as described with reference to FIGS. 8-11, the second frame member 28 may not be required, such as where the hinge 86 can be mounted directly to the container.

In practice, the latch 84 latches with a corresponding latch mechanism (not shown), which can be attached to the second frame member (where present) or to the container itself. The latch 84 prevents the cover 80 from being opened from the outside of the container. However, an individual on the inside of the container can unlatch the latch 84 and open the cover 80 from within the container.

Referring to FIG. 16, a cover 90 is illustrated according to various aspects of the present disclosure herein. The cover 90 includes cover surface 91 that is dimensioned to cover the corresponding apertures of the first and second frame members 22, 28. Thus, the cover 90 seals the hole through a corresponding container. A reflective feature 92 is provided on the cover surface. The reflective feature 92 is analogous to the reflective feature of 72.

The cover 90 differs from the cover 40 in the manner in which the cover interacts with the second frame member 28 and/or the container surface. Particularly, the tabs 44 in the cover 40 are replaced with a pivot 94 in the cover 90.

In this regard, the second frame member 28 need not include the locking feature as described with reference to FIGS. 4-5. Alternatively, the second frame member 28 may not be required, such as where the pivot 94 can be mounted directly to the container. In practice, the pivot 94 defines a stationary point for the cover 90. However, the cover surface 91 can be rotated about the pivot 94 so as to swing back and forth from inside the container. In its default position, the cover surface 91 hangs so as to cover the apertures through the corresponding container. However, in use, an individual can rotate the cover surface 91 by swinging the cover about the pivot 94 (optionally in either direction) so as to at least partially expose the apertures. The cover 90 may also interact with one or more locking devices (not show), which can be attached to the second frame member (where present) or to the container itself to provide a locked position such that the cover 90 cannot be opened from the outside of a corresponding container. However, an individual on the inside of the container can unlatch the locking device and open the cover 100 from within the container.

Aspects of the present disclosure relate to an access port adapted to be installed in an existing door of a semi-trailer or other suitable container. The access port is not large enough to allow a person to pass through. Rather, the access port is a one-way access port (i.e., can only be opened from the inside of the trailer). The access port is sized to allow a typical person reach an arm through the access port, but in a typical implementation, the access port is not much larger in diameter than an arm, e.g., 6 inches (15.24 cm) in diameter, placed about a foot or so (about 30.48 cm) from the outside latch. When installed in close proximity to an outside latch, a person on the inside of the trailer container can reach to the outside so as to unlatch the door, thus allowing the person to open the door from the inside.

More specifically, aspects of the present disclosure pertain to a frame which is inserted around a hole formed within an existing door of the trailer, which is positioned close to an outside door opening device, e.g., typically a latch. The hole thus forms an opening through the door. The frame includes in general, an outside frame member and an inside frame member that align together so as to frame the aperture in the door. For instance, where the aperture is generally round, the aperture may have a diameter of 4 inches (approximately 10.16 cm) to about 8 inches (approximately 20.32 cm). However, in practice, the aperture can be other sizes as the specific application dictates. Moreover, the hole can be placed within an arm's reach of the latch or other release mechanism on the outside of the door. In this regard the hole can be placed, for instance, within about one foot (about 30.48 cm) from the release mechanism. Alternatively, the hole can be placed closer or further away, e.g., possibly up to 18 inches (45.72 cm), or other distance as the specific application dictates.

The frame may be constructed from plastic, metal or other suitable material as the application dictates. Moreover, gaskets, seals and other additional features may be provided, e.g., to provide a water-tight seal with the container. Still further, the cover 40, 80, 90 may be clear, e.g., to allow light to pass through. Additionally, where the cover 40 completely separates from the second frame member 28, a harness, tether, strap, chain or other device can be utilized to keep the cover 40 associated with the access port. Still further, the aperture through the first frame member 22 need not match to the size and/or dimensions of the aperture through the second frame member 28.

Still further, the access port 20 can be utilized with other containers and door latching mechanisms. For instance, with reference to FIG. 15, the access port 20 works equally as well with an overhead opening door type of container.

The ability to open an access port within a container can find uses in terms of providing cooling and air circulation to the inside volume of the container. Moreover, where the access port is placed near a door latch, should the container close while someone is inside the container (e.g., through accident or otherwise), the otherwise trapped person can open the access port from the inside, by reaching an arm through the access port to reach and operate the latch. For instance, there are a number of scenarios where a person can become unintentionally trapped in the container. As an example, a worker that is working within the inside volume of the trailer may suddenly become trapped when wind or some other act inadvertently closes the door such that the door latches. As another example, a worker may accidentally close and latch the trailer door believing to be the last person to exit the trailer. Regardless, the access port is thus dimensioned so as to allow a user to reach through and bend sufficiently to grasp the latch or other release device and open the container door.

Although described in the context of a trailer, the container access port herein may be utilized with other containers that have a door that latches closed from the outside. While disclosed in general with regard to semi trailers, aspects of the present disclosure are not so limited. Rather, aspects of the present disclosure are usable with virtually any container large enough that a person can fit inside, having at least one door that latches shut from the outside. Other examples of suitable containers include a dry van trailer, a box van, a cargo container, a large storage locker, etc.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure.

Having thus described the disclosure of the present application in detail and by reference to embodiments thereof, it will be apparent that modifications and variations are possible without departing from the scope of the disclosure defined in the appended claims.

1. An access port for installation on a container, comprising:
a frame having:
a first frame member that has an aperture therethrough; and
a second frame member having an aperture therethrough, the second frame member also having a locking feature; and
a cover having a locking structure that mates with the locking feature of the second frame member;
wherein the locking structure of the cover interacts with the locking feature of the second frame member such that:
the cover releasably couples to the second frame member so as to sealingly close off the aperture through the second frame member when the locking structure of the cover engages the locking feature of the second frame member defining a closed position;
the cover at least partially detaches from the second frame member so as to expose the aperture through the second frame member when the locking structure of the cover is disengaged from the locking feature of the second frame member, thus defining an open position;
the cover is manually operable to transition between the closed position and the open position from a side defined by the second frame member; and
the cover is not manually operable between the closed position and the open position from a side defined by the first frame member.

2. The access port of claim 1, wherein:
the locking feature of the second frame member comprises at least one locking panel that forms a slot, and a corresponding release recess;
the locking structure of the cover includes at least one locking tab dimensioned relative to the release recess and locking panel such that when the cover is engaged against the second frame member and is rotated, the locking tab seats into the slot; and
at least one of the cover and the frame includes a gasket that forms a waterproof seal between the cover and the frame when the cover is engaged with the frame.

3. The access port of claim 1, wherein the first frame member and the second frame member are an integral assembly where the first frame member defines a flange and the second frame member defines an extension from the flange.

4. The access port of claim 1, wherein the first frame member is configured for mounting on the outside of a container surface and the second frame member is distinct from the first frame member and is configured for mounting to the inside surface of the container;
wherein:
the first frame member and the second frame member couple to each other using at least one fastener that passes through a first frame member surface and a second frame member surface so as to align the apertures through the first frame member and the second frame member.

5. The access port of claim 1, wherein the cover is tethered to the frame.

6. The access port of claim 1 further comprising a segmented flap that is positioned between the first and second frame members so as to seal the apertures therebetween.

7. The access port of claim 1 further comprising a reflective feature on the cover so as to provide an indication of the location of the cover from within a corresponding container to which the assess port is mounted.

8. A kit of components that are assembled to define an access port for installation on a container, comprising:
a frame having:
a first frame member that has an aperture therethrough, wherein the aperture is less than one foot (30.48 centimeters); and
a cover having a hinge;
wherein:
the frame is configured to overlie a hole cut into a corresponding container such that the aperture aligns with the hole, the frame on the outside of the container;
the cover is dimensioned to be larger than the hole cut in a corresponding container; and
the hinge of the cover is configured to attach to an inside surface of a container proximate to the hole such that when the cover is closed, the cover overlies the hole and when the cover is open, the hole is exposed through the frame.

9. The kit according to claim 8, wherein the cover further comprises a latch, wherein:
the latch of the cover latches to a corresponding latch mechanism attached to the inside surface of the container such that the latch can be operated from the inside of the container but not from the outside of the container.

10. The kit according to claim 8, wherein the hinge comprises a pivot such that the cover can be opened relative to the hole by rotating the cover thus pivoting the cover away from the hole.

11. A container comprising:
a container body having a door that is opened by operating a door opening device located on the outside of the container body, the container having a hole proximate to the door opening device that extends through the container;
a frame having:
a first frame member that has an aperture therethrough, the first frame member secured to the outside of the container such that the aperture of the first frame member aligns with the hole in the container; and
a second frame member having an aperture therethrough, the second frame member also having a locking feature; and
a cover having a locking structure that mates with the locking feature of the second frame member;
wherein the locking structure of the cover interacts with the locking feature of the second frame member such that:
the cover releasably couples to the second frame member so as to sealingly close off the aperture through the second frame member when the locking structure of the cover engages the locking feature of the second frame member defining a closed position;
the cover at least partially detaches from the second frame member so as to expose the aperture through the second frame member when the locking structure of the cover is disengaged from the locking feature of the second frame member, thus defining an open position;
the cover is manually operable to transition between the closed position and the open position from a side defined by the second frame member; and
the cover is not manually operable between the closed position and the open position from a side defined by the first frame member.

12. The container of claim 11, wherein:
the locking feature of the second frame member comprises at least one locking panel that forms a slot, and a corresponding release recess;
the locking structure of the cover includes at least one locking tab dimensioned relative to the release recess and locking panel such that when the cover is engaged against the second frame member and is rotated, the locking tab seats into the slot; and
at least one of the cover and the frame includes a gasket that forms a waterproof seal between the cover and the frame when the cover is engaged with the frame.

13. The container of claim 11, wherein the first frame member and the second frame member are an integral assembly where the first frame member defines a flange and the second frame member defines an extension from the flange that extends through the hole in the container.

14. The container of claim 11, wherein the second frame member is distinct from the first frame member and is mounted to the inside surface of the container;
wherein:
the first frame member and the second frame member couple to each other using at least one fastener that passes through a first frame member surface and a second frame member surface so as to align the apertures through the first frame member and the second frame member.

15. The container of claim 11, wherein the cover is tethered to the frame.

16. The container of claim 11, further comprising a segmented flap that is positioned between the first and second frame members so as to seal the apertures therebetween.

17. The container of claim 11, further comprising a reflective feature on the cover so as to provide an indication of the location of the cover from within a corresponding container to which the assess port is mounted.

18. (canceled)

19. (canceled)

20. (canceled)

21. The access port of claim 1, wherein the aperture of the first frame member is at least 6 inches (15.24 centimeters) in diameter.

22. The access port of claim 1, wherein the aperture of the first frame member is less than 6 inches (15.24 centimeters) in diameter.

23. The kit of components of claim 8, wherein:
the aperture through the first frame member is further at least 6 inches (15.24 centimeters) in diameter.
